(19) United States
(12) Patent Application Publication
(10) Pub. No.: US 2005/0233734 A1
(43) Pub. Date: Oct. 20, 2005

(54) Wireless network and mobile stations implementing protocol revision independent features

(75) Inventors: Purva R. Rajkotia, Plano, TX (US); Chanakya Bandyopadhyay, Richardson, TX (US)

Correspondence Address: DOCKET CLERK, P.O. DRAWER 800889, DALLAS, TX, 75380, US

(73) Assignee: SAMSUNG ELECTRONICS CO., LTD., Suwon-City (KR)

(21) Appl. No.: 11/068,189

(22) Filed: Feb. 28, 2005

Related U.S. Application Data
(60) Provisional application No. 60/562,863, filed on Apr. 16, 2004.

(51) Int. Cl. H04Q 7/20

(52) U.S. Cl. 455/414.1; 455/403

(57) ABSTRACT

A base station for communicating with mobile stations in a coverage area of a wireless network. The base station comprises a database for storing a list of service features supported by the base station. The service features are associated with a particular revision of an air interface protocol under which the base station operates. The base station also comprises a base station messaging controller for receiving a control channel message from a first mobile station and retrieving from the control channel message a Feature Capability Record associated with the first mobile station. The Feature Capability Record identifies a plurality of service features associated with the particular revision of the air interface protocol that are supported by the first mobile station.

### CROSS-REFERENCE TO RELATED APPLICATION AND CLAIM OF PRIORITY

The present invention is related to that disclosed in U.S. Provisional Patent No. 60/562,863, filed Apr. 16, 2004, entitled “Protocol Revision Independent Features”. U.S. Provisional Patent No. 60/562,863 is assigned to the assignee of the present application. The subject matter disclosed in U.S. Provisional Patent No. 60/60/562,863 is hereby incorporated by reference into the present disclosure as if fully set forth herein. The present invention hereby claims priority under 35 U.S.C. §119(e) to U.S. Provisional Patent No. 60/60/562,863.

### TECHNICAL FIELD OF THE INVENTION

The present invention relates generally to wireless network and, more specifically, to a base station and a mobile station that implement features independently of the revision of the air interface protocol.

### BACKGROUND OF THE INVENTION

Business and consumers use a wide variety of fixed and mobile wireless terminals, including cell phones, pagers, Personal Communication Services (PCS) systems, and fixed wireless access devices (i.e., vending machine with cellular capability). Wireless service providers continually try to create new markets for wireless devices and expand existing markets by making wireless devices and services cheaper and more reliable. To attract new customers, wireless service providers implement new services, especially digital data services that, for example, enable a user to browse the Internet or send and receive e-mail.

New features provided by wireless service providers are often grouped together in releases of a particular wireless protocol revision. As a result, the features which are introduced in the standards are normally tied to the protocol revision. For example, Feature X introduced in Release Y of CDMA2000 with Protocol Revision Z may not be implemented in prior releases. Furthermore, in order to implement Feature X, all of the other features that are mandatory for Release Y of CDMA2000, Protocol Revision Z, must also be implemented.

Frequently, a wireless service provider may not need all of the mandatory features of a particular release, but because of the tie-in with the Protocol Revision, the wireless service provider is forced to pay for unwanted features. Thus, even though the wireless service provider may be interested in only one feature from a particular release, the wireless service provider must implement all of the mandatory features associated with the release. This makes the product more expensive and often late to the market.

Moreover, a feature may be optional for both the base station and the mobile station. To determine whether a feature is supported by both the base station and the mobile station, negotiations must be performed between the base station and the mobile station. This negotiation process increases overhead time in the final call set-up.

Therefore, there is a need in the art for improved base stations and mobile stations that are able to implement desired service features without implementing all of the service features associated with a particular release of a protocol revision.

### SUMMARY OF THE INVENTION

The present invention overcomes the shortcomings of the prior art by making the service features independent of the protocol revision. The present invention accomplishes this by means of a Feature Capability Record that details all of the features supported, along with the required parameters to make the feature operational. The new Feature Capability Record may be implemented as part of an existing control channel message (e.g., Origination message, ECAM) or may be implemented as a new special-purpose message. The present invention may be used for all the mobile stations and the base stations independent of protocol revision. Using the length field in the feature capability record avoids parsing problems whenever a mobile station talks with a higher release base station, or vice-versa.

To address the above-discussed deficiencies of the prior art, it is a primary object of the present invention to provide, for use in a wireless network, a base station capable of communicating with a plurality of mobile stations in a coverage area of the wireless network. According to an advantageous embodiment of the present invention, the base station comprises: 1) a database for storing a list of service features supported by the base station, wherein the service features are associated with a particular revision of an air interface protocol under which the base station operates; and 2) a base station messaging controller capable of receiving a control channel message from a first one of the plurality of mobile stations and retrieving from the control channel message a Feature Capability Record associated with the first mobile station, wherein the Feature Capability Record identifies a plurality of service features associated with the particular revision of the air interface protocol that are supported by the first mobile station.

According to one embodiment of the present invention, the control channel message is a special-purpose control channel message for transmitting the Feature Capability Record.

According to another embodiment of the present invention, the control channel message is one of an Origination message, a Page Response message, and a Status Response message.

According to still another embodiment of the present invention, the base station messaging controller compares the plurality of service features supported by the first mobile station with the list of service features supported by the base station.

According to yet another embodiment of the present invention, the base station, in response to the comparison, allocates resources to a call associated with the first mobile station.

According to a further embodiment of the present invention, the Feature Capability Record comprises a first Feature Record associated with a first service feature supported by the first mobile station.

According to a still further embodiment of the present invention, the first Feature Record comprises a Feature Identifier field containing a unique identifier value associated with the first service feature.

According to a yet further embodiment of the present invention, the first Feature Record further comprises a Feature Information Length field containing a length value associated with the first Feature Record.

According to another embodiment of the present invention, the first Feature Record further comprises a Feature Block of Bits field containing parameters associated with the first service feature.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,”is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network in which base stations and mobile stations implement protocol revision independent features according to the principles of the present invention;

FIG. 2 illustrates an exemplary base station that implements protocol revision independent features according to the principles of the present invention;

FIG. 3 illustrates an exemplary mobile station that implements protocol revision independent features according to the principles of the present invention;

FIG. 4 illustrates an exemplary Feature Capability Record according to one embodiment of the present invention; and

FIG. 5 is a message flow diagram illustrating the operation of a base station and a mobile station implementing protocol revision independent features according to an exemplary embodiment of the present invention.

### DETAILED DESCRIPTION OF THE INVENTION

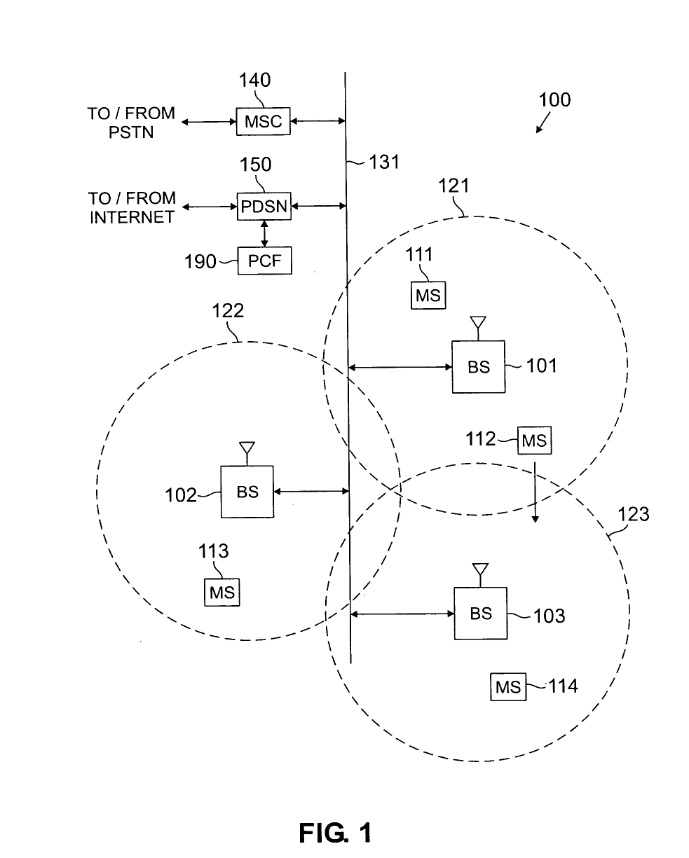

FIGS. 1 through 5, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 illustrates exemplary wireless network 100, in which base stations and mobile stations implement protocol revision independent features according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to, for example, the IS-2000 standard (i.e., CDMA2000). In an advantageous embodiment of the present invention, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present invention is not limited to mobile devices. The present invention also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, each of cell sites 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present invention is not limited to any particular cell site configuration.

In one embodiment of the present invention, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

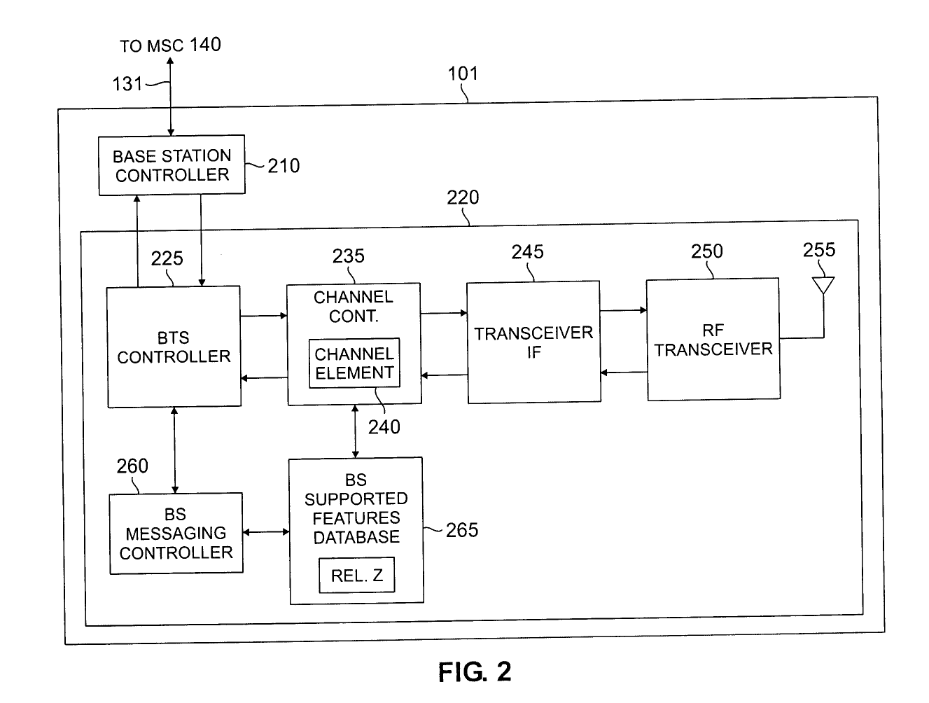

FIG. 2 illustrates exemplary base station 101, which implements protocol revision independent features according to the principles of the present invention. Base station 101 comprises base station controller (BSC) 210 and base transceiver station (BTS) 220. Base station controllers and base transceiver stations were described previously in connection with FIG. 1. BSC 210 manages the resources in cell site 121, including BTS 220. BTS 120 comprises BTS controller 225, channel controller 235 (which contains representative channel element 240), transceiver interface (IF) 245, RF transceiver 250, and antenna array 255.

BTS controller 225 comprises processing circuitry and memory capable of executing an operating program that controls the overall operation of BTS 220 and communicates with BSC 210. Under normal conditions, BTS controller 225 directs the operation of channel controller 235, which contains a number of channel elements, including channel element 240, that perform bi-directional communications in the forward channel and the reverse channel. A “forward” channel refers to signals transmitted from the base station to the mobile station and a “reverse” channel refers to signals transmitted from the mobile station to the base station. Transceiver IF 245 transfers the bi-directional channel signals between channel controller 240 and RF transceiver 250.

Antenna array 255 transmits forward channel signals received from RF transceiver 250 to mobile stations in the coverage area of BS 101. Antenna array 255 also sends to RF transceiver 250 reverse channel signals received from mobile stations in the coverage area of BS 101. In a preferred embodiment of the present invention, antenna array 255 is multi-sector antenna, such as a three-sector antenna in which each antenna sector is responsible for transmitting and receiving in a 120° arc of coverage area. Additionally, RF transceiver 250 may contain an antenna selection unit to select among different antennas in antenna array 255 during both transmit and receive operations.

BTS 120 further comprises base station (BS) messaging controller 260 and base station (BS) supported features database 265. BS messaging controller 260 is responsible for communicating with mobile stations in the overhead control channels (e.g., paging, access, sync channels). In the illustrated embodiment in FIG. 2, BS messaging controller 260 is shown as a device separate from BTS controller 225. However, this is for the purposes of simplicity and clarity in illustrating and explaining the operations of the present invention. In an alternate embodiment of the present invention, BS messaging controller 260 may be implemented as an integral part of (i.e., a function of) BTS controller 225.

As stated above, service features that are introduced in the standards are tied to a particular protocol revision. Implementing all of the features tied to each protocol revision causes delay in delivering the product and increases the cost of the product. Moreover, in each standard, many features are optional for the base station and the mobile station. Verifying whether or not the mobile station and the base station both support a particular features requires a negotiations process that delays the set-up time of the call.

To overcome these disadvantage, the present invention provides a new record—the Feature Capability Record—that is added to the air interface specification. In one embodiment of the present invention, the new Feature Capability Record may be implemented as part of a conventional control channel or data channel message (e.g., Origination message, ECAM) in the CDMA200 standard. In an alternate embodiment of the present invention, the new Feature Capability Record may be implemented as part of a new special-purpose control channel (or data channel) message. The service features that are included in the Feature Capability Record are the ones supported by the mobile station or the base station, independent of the P_REV (Protocol Revision).

BS supported features database 265 stores a list of features of Release Z of the protocol revision under which base station 101 operates that are supported by base station 101. As will be explained below in greater detail, BS messaging controller 260 uses the supported features information stored in BS supported features database 265 to generate a BS Feature Capability Record that is transmitted to mobile stations communicating with BS 101. Each mobile station transmits to BS 101 a similar MS Feature Capability Record containing information about the features of Release Z of the protocol revision under which each mobile station operates that are supported by each mobile station.

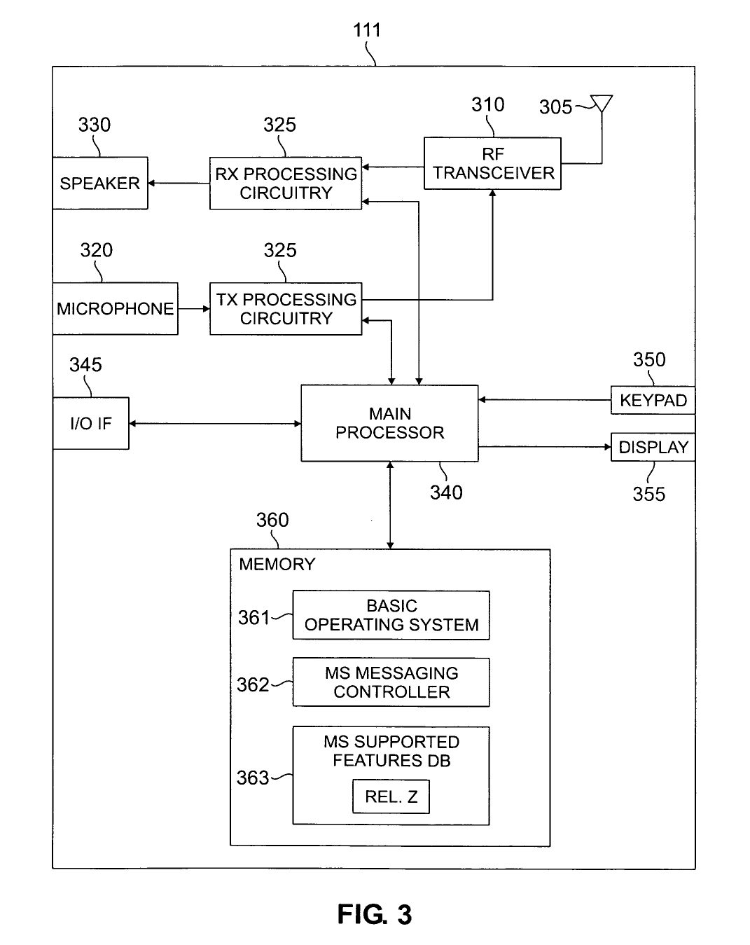

FIG. 3 illustrates exemplary mobile station ill, which implements protocol revision independent features according to the principles of the present invention. Mobile station 111 comprises antenna 305, radio frequency (RF) transceiver 310, transmit (TX) processing circuitry 315, microphone 320, and receive (RX) processing circuitry 325. MS 111 also comprises speaker 330, main processor 340, input/output (I/O) interface (IF) 345, keypad 350, display 355, and memory 360. Memory 360 further comprises basic operating system (OS) program 361, mobile station (MS) messaging controller program 362, and mobile station (MS) supported features database 363.

Radio frequency (RF) transceiver 310 receives from antenna 305 an incoming RF signal transmitted by a base station of wireless network 100. Radio frequency (RF) transceiver 310 down-converts the incoming RF signal to produce an intermediate frequency (IF) or a baseband signal. The IF or baseband signal is sent to receiver (RX) processing circuitry 325 that produces a processed baseband signal by filtering, decoding, and/or digitizing the baseband or IF signal. Receiver (RX) processing circuitry 325 transmits the processed baseband signal to speaker 330 (i.e., voice data) or to main processor 340 for further processing (e.g., web browsing).

Transmitter (TX) processing circuitry 315 receives analog or digital voice data from microphone 320 or other outgoing baseband data (e.g., web data, e-mail, interactive video game data) from main processor 340. Transmitter (TX) processing circuitry 315 encodes, multiplexes, and/or digitizes the outgoing baseband data to produce a processed baseband or IF signal. Radio frequency (RF) transceiver 310 receives the outgoing processed baseband or IF signal from transmitter (TX) processing circuitry 315. Radio frequency (RF) transceiver 310 up-converts the baseband or IF signal to a radio frequency (RF) signal that is transmitted via antenna 305.

In an advantageous embodiment of the present invention, main processor 340 is a microprocessor or microcontroller. Memory 360 is coupled to main processor 340. According to an advantageous embodiment of the present invention, part of memory 360 comprises a random access memory (RAM) and another part of memory 360 comprises a Flash memory, which acts as a read-only memory (ROM).

Main processor 340 executes basic operating system (OS) program 361 stored in memory 360 in order to control the overall operation of wireless mobile station 111. In one such operation, main processor 340 controls the reception of forward channel signals and the transmission of reverse channel signals by radio frequency (RF) transceiver 310, receiver (RX) processing circuitry 325, and transmitter (TX) processing circuitry 315, in accordance with well-known principles.

Main processor 340 is capable of executing other processes and programs resident in memory 360. Main processor 340 can move data into or out of memory 360, as required by an executing process. Main processor 340 is also coupled to I/O interface 345. I/O interface 345 provides mobile station 111 with the ability to connect to other devices such as laptop computers and handheld computers. I/O interface 345 is the communication path between these accessories and main controller 340.

Main processor 340 is also coupled to keypad 350 and display unit 355. The operator of mobile station 111 uses keypad 350 to enter data into mobile station 111. Display 355 may be a liquid crystal display capable of rendering text and/or at least limited graphics from web sites. Alternate embodiments may use other types of displays.

MS messaging controller program 362 is responsible for communicating with base station 101 in the overhead control channels (e.g., paging, access, sync channels). In the illustrated embodiment in FIG. 3, MS messaging controller program 362 is shown as a program separate from basic operating system program 361. However, this is for the purposes of simplicity and clarity in illustrating and explaining the operations of the present invention. In an alternate embodiment of the present invention, MS messaging controller program 362 may be implemented as an integral part of (i.e., a function of) basic operating system program 361.

MS supported features database 363 stores a list of features of Release Z of the protocol revision under which mobile station 111 operates that are supported by mobile station 111. As will be explained below in greater detail, MS messaging controller program 362 uses the supported features information stored in MS supported features database 363 to generate an MS Feature Capability Record that is transmitted to base station 101.

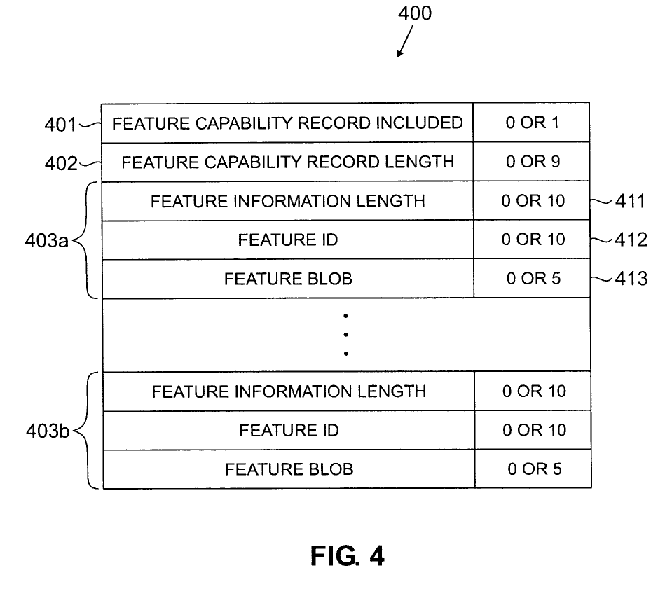

FIG. 4 illustrates exemplary Feature Capability Record 400 according to one embodiment of the present invention. Feature Capability Record 400 provides the list of features that are supported by the particular device (i.e., base station or mobile station). According to the principles of the present invention, mobile station 111 may transmit Feature Capability Record 400 as part of a conventional control channel message, such as an Origination message (ORM), a Page Response message (PRM), or a Status Response message. Base station 101 may transmit Feature Capability Record 400 as part of a conventional control channel message, such as a Universal Handoff Direction message (UHDM) or an Extended Channel Assignment message (ECAM).

Feature Capability Record 400 comprises Feature Capability Record Included field 401, Feature Capability Record Length 402, and one or more Feature Records 403, such as exemplary Feature Records 403a and 403b. Each service feature that is supported by a mobile station or a base station is associated with its own Feature Record 403. Exemplary Feature Record 403a comprises Feature Information Length field 411, Feature ID field 412, and Feature Block of Bits (BLOB) field 413.

Feature Capability Record Included field 401 comprises either a 0-bit field, if Feature Capability Record 400 is not present, or a 1-bit field, if Feature Capability Record 400 is included as part of a control channel message. Feature Capability Record Length comprises a 0-bit (if Feature Capability Record 400 is not present) or 9-bit field that indicates the total length of Feature Capability Record 400, including all Feature Record(s) 403.

Each service feature is identified by a unique Feature ID value in Feature ID field 412. Feature ID field 412 may be a 0-bit field (if Feature Capability Record 400 is not present) or a 10-bit field identifying the particular feature. The total length of each Feature Record 403 is stored in Feature Information Length field 411. Feature Information Length field 411 may be a 0-bit field (if Feature Capability Record 400 is not present) or a 10-bit field identifying the length of Feature Record 403. Feature Block of Bits (BLOB) field 413 contains all of the operational parameters that are required to enable the service feature associated with Feature Record 403. Feature Block of Bits (BLOB) field 413 may be a 0-bit field (if Feature Capability Record 400 is not present) or, for example, a 5-bit field identifying the length of Feature Record 403.

Each Feature Record 403 has its own length field and Feature Capability Record 400 has its own overall length field, which avoids problems with parsing, since each one of base station 101 and mobile station 111 always knows the record length to be parsed. Hence, if additional records are added in future revisions, there still will not be a parsing problem, since the mobile station or the base station implementing the new features will change the total record length accordingly.

According to an advantageous embodiment of the present invention, BS messaging controller 260 or MS messaging controller program 362 may avoid sending the entire Feature Capability Record 400 in FIG. 4 as part of the overhead control message, thereby preventing the overhead control message (i.e., ORM, PRM, UHDM, ECAM, etc.) from becoming too long. To accomplish this, BS messaging controller 260 or MS messaging controller program 362 may transmit only the desired values for Feature ID field 412 in Feature Capability Record 400. Thus, the overall message length becomes shorter, since there is no need to send the Feature BLOB field 413, and the required information is still conveyed.

The use of Feature BLOB field 413 ensures that the problems of backwards compatibility do not arise. Base station 101 and mobile station 111 are able to skip the parsing of Feature BLOB field 413 if a particular feature is not supported.

Advantageously, Feature Capability Record 400 may be sent on the forward and reverse control channels (F/R-CSCH) or the forward and reverse data supplemental channels (F/R-DSCH) messages. If Feature Capability Record 400 is sent by itself in a unique special-purpose message, rather than in a conventional control channel message, there is no need to include the Feature Capability Record Included field 411. As new features are introduced in subsequent standards, the new features receive new Feature ID values and respective parameters. The present invention also enables the support of the proprietary features, if need be. The base station and the mobile station agree upon some particular Feature ID to be used and the corresponding Feature BLOB field.

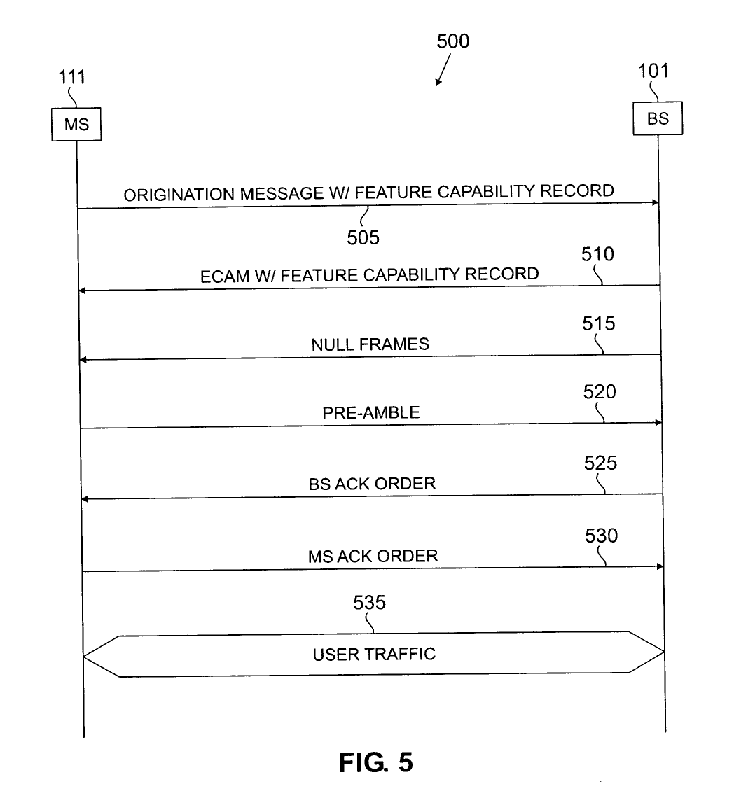

FIG. 5 depicts message flow diagram 400, which illustrates the operations of base station (BS) 101 and mobile station (MS) 111, which implement protocol revision independent features according to the principles of the present invention. Initially, MS messaging controller program 362 in mobile station 111 originates a call by transmitting Origination message 505 to base station 101. Origination message 505 is modified to contain Feature Capability Record 400, as shown in FIG. 4, according to the principles of the present invention.

BS messaging controller 260 examines the information in Feature Capability Record 400 transmitted by MS 111 to determine the service features supported by MS 111 and compares this information with the information stored in BS supported features database 265. Once the service features supported by both MS 111 and BS 101 are identified, BTS controller 225 allocates resources to support the call with MS 111.

In response to the allocation of resources, BS messaging controller 260 transmits Extended Channel Assignment message (ECAM) 510 to MS 111. According to the principles of the present invention, ECAM 510 also contains Feature Capability Record 400, as shown in FIG. 4, which identifies the service features that are supported by BS 101. MS messaging controller program 362 examines the information in Feature Capability Record 400 transmitted by BS 101 to determine the service features supported by BS 101 and compares this information with the information stored in MS supported features database 363. Once the service features supported by both MS 111 and BS 101 are identified, MS messaging controller program 362 thereafter only requests service features that are supported by BS 101. This avoids the rejection of requests for service features that are not supported by BS 101 and saves bandwidth in the forward and reverse channels.

Thereafter, BS 101 transmits null frames 515 to MS 111 and MS 111 transmits Preamble 520 to BS 101. When BS 101 and MS 101 are synchronized to each other, BS 101 transmits BS Acknowledgment Order 525 to MS 111 and MS 111 responds by transmitting MS Acknowledgment Order 530 to BS 101. Thereafter, user traffic 535 is exchanged between BS 101 and MS 111 in the forward and reverse traffic channels.

The scenario depicted in FIG. 5 illustrates an example in which the call is initiated by mobile station 111. However, those skilled in the art will understand that flow diagram 500 may be readily adapted to accommodate calls that are terminated at mobile station 111. If a call is terminated at MS 111, BS 101 initially transmits a Paging message to MS 111. MS messaging controller program 362 responds by transmitting a Page Response message (PRM) than contains Feature Capability Record 400 according to the principles of the present invention. The call flow then proceeds as in FIG. 5, beginning at ECAM 510.

Although the present invention has been described with an exemplary embodiment, various changes and modifications may be suggested to one skilled in the art. It is intended that the present invention encompass such changes and modifications as fall within the scope of the appended claims.

1. For use in a wireless network, a base station capable of communicating with a plurality of mobile stations in a coverage area of said wireless network, said base station comprising:
a database for storing a list of service features supported by said base station, wherein said service features are associated with a particular revision of an air interface protocol under which said base station operates; and
a base station messaging controller capable of receiving a control channel message from a first one of said plurality of mobile stations and retrieving from said control channel message a Feature Capability Record associated with said first mobile station, wherein said Feature Capability Record identifies a plurality of service features associated with said particular revision of said air interface protocol that are supported by said first mobile station.

2. The base station as set forth in claim 1, wherein said control channel message is a special-purpose control channel message for transmitting said Feature Capability Record.

3. The base station as set forth in claim 1, wherein said control channel message is one of an Origination message, a Page Response message, and a Status Response message.

4. The base station as set forth in claim 1, wherein said base station messaging controller compares said plurality of service features supported by said first mobile station with said list of service features supported by said base station.

5. The base station as set forth in claim 4, wherein said base station, in response to said comparison, allocates resources to a call associated with said first mobile station.

6. The base station as set forth in claim 5, wherein said Feature Capability Record comprises a first Feature Record associated with a first service feature supported by said first mobile station.

7. The base station as set forth in claim 6, wherein said first Feature Record comprises a Feature Identifier field containing a unique identifier value associated with said first service feature.

8. The base station as set forth in claim 7, wherein said first Feature Record further comprises a Feature Information Length field containing a length value associated with said first Feature Record.

9. The base station as set forth in claim 8, wherein said first Feature Record further comprises a Feature Block of Bits field containing parameters associated with said first service feature.

10. A mobile station capable of communicating with a wireless network comprising a plurality of base stations, said mobile station comprising:
a database for storing a list of service features supported by said mobile station, wherein said service features are associated with a particular revision of an air interface protocol under which said mobile station operates; and
a mobile station messaging controller capable of transmitting a control channel message to a first one of said plurality of base stations, said control channel message containing a Feature Capability Record associated with said first mobile station, wherein said Feature Capability Record identifies to said first base station a plurality of service features associated with said particular revision of said air interface protocol that are supported by said first mobile station.

11. The mobile station as set forth in claim 10, wherein said control channel message is a special-purpose control channel message for transmitting said Feature Capability Record.

12. The mobile station as set forth in claim 10, wherein said control channel message is one of an Origination message, a Page Response message, and a Status Response message.

13. A wireless network comprising a plurality of base stations capable of communicating with a plurality of mobile stations in a coverage area of said wireless network, wherein each of said plurality of base station comprises:
a database for storing a list of service features supported by said each base station, wherein said service features are associated with a particular revision of an air interface protocol under which said each base station operates; and
a base station messaging controller capable of receiving a control channel message from a first one of said plurality of mobile stations and retrieving from said control channel message a Feature Capability Record associated with said first mobile station, wherein said Feature Capability Record identifies a plurality of service features associated with said particular revision of said air interface protocol that are supported by said first mobile station.

14. The wireless network as set forth in claim 13, wherein said control channel message is a special-purpose control channel message for transmitting said Feature Capability Record.

15. The wireless network as set forth in claim 13, wherein said control channel message is one of an Origination message, a Page Response message, and a Status Response message.

16. The wireless network as set forth in claim 13, wherein said base station messaging controller compares said plurality of service features supported by said first mobile station with said list of service features supported by said each base station.

17. The wireless network as set forth in claim 16, wherein said base station, in response to said comparison, allocates resources to a call associated with said first mobile station.

18. The wireless network as set forth in claim 17, wherein said Feature Capability Record comprises a first Feature Record associated with a first service feature supported by said first mobile station.

19. The wireless network as set forth in claim 18, wherein said first Feature Record comprises a Feature Identifier field containing a unique identifier value associated with said first service feature.

20. The wireless network as set forth in claim 19, wherein said first Feature Record further comprises a Feature Information Length field containing a length value associated with said first Feature Record.
